(19) United States
(12) Patent Application Publication
(10) Pub. No.: US 2005/0280514 A1
(43) Pub. Date: Dec. 22, 2005

(54) Apparatus for monitoring and displaying vehicular operational status

(76) Inventor: Duc Doan, Los Angeles, CA (US)

Correspondence Address: Edward E. Roberts, P.O. Box 3206, Dana Point, CA, 92629, US

(21) Appl. No.: 10/871,633

(22) Filed: Jun. 21, 2004

(51) Int. Cl. B60Q 1/00; G08B 1/08

(52) U.S. Cl. 340/425.5; 340/438; 340/539.1

(57) ABSTRACT

An information assembly for monitoring vehicular operational parameters that contributes to dangerous vehicular operation. The driver of the vehicle may also be monitored. The assembly includes a microprocessor for data analysis to determine driver and vehicular operational anomalies. An information display area is installed interior of the vehicle to be viewable by the driver, and at least one display unit installed to be viewable exterior of the vehicle. The display viewable by exterior observers can be installed on the vehicle or at some other convenient location. Wireless transmission capabilities are included for exterior display of the processed information.

### BACKGROUND OF THE INVENTION

The background of the invention will be discussed in two parts.

1. Field of the Invention

The invention relates to monitoring and display of vehicle operational conditions, and in particular to apparatus for communication of such conditions to observers exterior of the vehicle, including wireless transmission of such conditions to receivers exterior of the vehicle.

2. Description of the Prior Art

Society is highly concerned with roadway safety and has an interest in diminishing driver and vehicular problems contributing to dangerous vehicular operation. In many instances drivers will not engage in proper driving habits, oftentimes having a propensity to ignore safe driving habits as well as the operational condition of their vehicle. Vehicle operational problems include bad brakes, low tire pressure, and the like, and driver oversights include unfastened seatbelts, inadequate gasoline and the like. Usually vehicle problems and driver oversights, and especially the operational status of the vehicle, takes place without cognizance of other drivers, and even of the driver himself.

If, in addition to proper notification to the driver, improper vehicular operational status and driver information is also displayed or otherwise communicated exterior of the vehicle it could provide approaching motorists with valuable information thus contributing greatly to vehicular safety. Availability of this information would also be valuable to law enforcement in keeping the roads safer. Present prior art safeguards do not provide for exterior communication of a vehicle's operational status, or of the driver's attention to this status, at the time the vehicle is most dangerous, that is, when it is being driven on the road.

Conventional passenger and cargo vehicles typically provide certain information displayed to the driver relative to operational status of the vehicle, these displays normally in the instrument panel directly in front of the driver. Certain ancillary displays, such as time and outside temperature, are often included in the display. However, for various reasons the driver may not notice a critical warning display relating to occupant safety or vehicle operation. In some instances, in recognition of information display viewing problems, vehicle manufacturers have placed information displays in consoles attached to the headliner of the vehicle above the front windshield, however, even this is often not adequate either in that critical warnings are not noticed or that not enough operational or safety parameters are monitored and displayed.

In recognition of problems in the prior art, the present invention provides for display units to be mounted such that selected data are displayed both interior of the vehicle and exterior of the vehicle such as to be readable by observers exterior of the vehicle. Such displays provide important information to the driver as well as simultaneously to outside observers thus adding an additional measure of safety. For instance, following motorists can be put on notice of vehicle and driver operational problems and thus exercise necessary caution. Gas station attendants can notice and advise of problems, and law enforcement officers can be made aware of problems having propensity to cause accidents. Operational status may also be displayed interior of the vehicle for driver pre-trip inspection as well as inspection by the driver during trip operation of the vehicle. This information may be displayed exterior of the vehicle if desired. The invention further provides for wireless transmission and reception of selected operational data.

It is thus an aspect of the invention to provide monitoring and display apparatus having provision for displaying operational conditions of a vehicle, as well certain driver oversights, to the driver, and to others positioned exterior of the vehicle, the ability including wireless transmission of the data. The foregoing and other objects, features and advantages of the invention will become readily apparent from a reading of the specification when taken in conjunction with the drawings in which like reference numerals refer to like elements in the several views.

### SUMMARY

The invention provides means for monitoring the status of vehicular operational conditions and when they become a problem according to preset guidelines, providing an alert signal that can be displayed or otherwise communicated as desired interior and/or exterior of the vehicle. Examples of such operational conditions are low brake fluid, low tire pressure, excess radiator temperature, low oil pressure, low fuel, unfastened seatbelt, air brakes for trucks, excess speed, etc. Provision for conditions not generally monitored, but desirable to be monitored, may be made with installation of additional monitoring equipment. Certain driver conditions may also be monitored and displayed or otherwise communicated as desired.

Information is typically displayed visibly exterior of the vehicle at a position to the rear or to the side of the vehicle. For instance, when an “alert” signal is sent from a monitor to an interior display, this signal can also be sent to a display unit visible from the rear or side of the vehicle. The unit for exterior display can be mounted either inside or outside of the vehicle such as to be adequately visible to one outside the vehicle. The invention provides for automatic and manual monitoring of vehicle operational parameters at pre-ignition, at ignition, and during operation of the vehicle. In addition to override or interruption of signal representations, aberrational signals may be used to prevent ignition of the vehicle. Also, in addition to conventional visual signal representations, audible signals may be used to alert the operator of the vehicle. These signals may be designed to continue for a period of time and then revert to a normal condition. Provision is also made for wireless communication of selected information to receivers exterior of the vehicle.

In new vehicles having properties of the invention included at manufacture, the interior display is typically included in the dashboard with necessary electronics and wiring for both the interior and exterior displays concealed. For after-market installation the interior and exterior displays and associated wiring, including wireless transmission electronics, are to be located to provide adequate visibility by the driver and housed to minimize obstructions and maximize appearance.

### DRAWINGS

FIG. 1 is a plan view of an interior display providing driver visibility of monitored operational parameters;

FIG. 2 is a plan view of an example of an exterior display in accordance with the invention providing vehicular operational status for observer visibility exterior of the vehicle;

FIG. 3 illustrates an example of positioning of built-in displays for visibility of vehicular operational status by observers exterior of the vehicle;

FIG. 4 is a plan view of an example of positioning of exterior displays for visibility of vehicular operational status by the driver of a following vehicle;

FIG. 5 is a plan view of another example of exterior positioning of displays for visibility of vehicular operational status to observers exterior of the vehicle;

FIG. 6 is a plan view of another example of built-in positioning of displays for visibility of vehicular operational status to observers exterior of the vehicle;

FIG. 7 is a functional block diagram depicting the various functions of the electronic circuitry of the apparatus of the invention;

FIG. 8 is a side elevational view of a truck and trailer, the trailer displaying information received by wireless transmission from the truck.

FIG. 9 is a functional block diagram depicting various functions of the electronic circuitry of the apparatus of the invention and further illustrates the use of wireless transmission of operational status; and

FIG. 10 is a functional block diagram further depicting functions of the electronic circuitry of the apparatus of the invention and illustrates the reception of wireless transmission of operational status.

### DESCRIPTION

Referring to the drawings in general there is illustrated and disclosed apparatus for monitoring of vehicular operational conditions and driver status and providing this information for cognizant communication to the vehicle driver and/or to observers exterior of the vehicle. Means for such communication include interior and/or exterior display units as well as wireless communication to receivers exterior of the vehicle. Such receivers in turn have means of selected communication to desired recipients. Although other configurations may be used, the apparatus shown and described is typical and comprises in general, monitoring devices, data processing electronics, wireless transmission capabilities, and display units. Video monitoring and audio alert means may also be included.

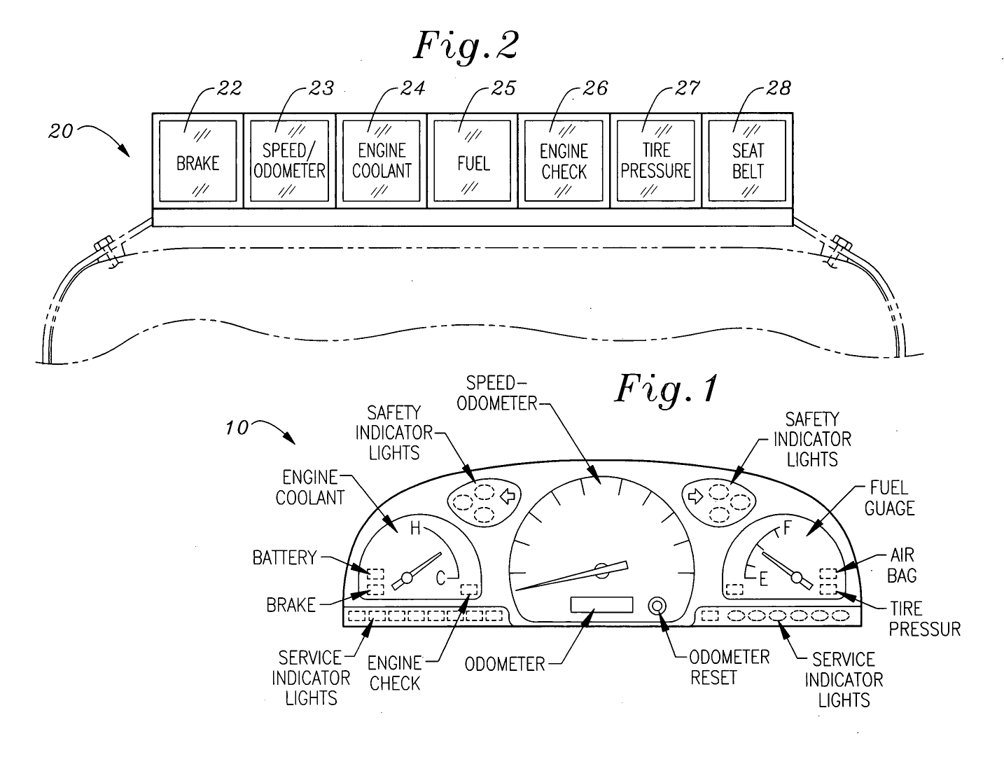

In FIG. 1 there is shown an interior information display, such as is conventionally positioned on the dashboard of a vehicle, providing driver visibility of monitored vehicular operational conditions. The interior information display, generally designated 10, can be a panel of any conventional light emitting characteristics so that information is displayed as illuminated indicia. By way of example, the interior information display 10 may include a variety of vehicle operational gauges and/or indicator lights. In accordance with the invention, such a display unit and its associated electronics are modified to include additional monitoring and display as will be described. Further, various configurations of display units for viewing by observers exterior of the vehicle are included.

FIG. 2 illustrates display unit 20, one example of a display unit as may be installed exterior of a vehicle suitable for after-market installation. Information as provided to the driver by interior display 10, as well as other selected information, can be provided to the remote display 20. By way of example, display unit 20 illustrates certain vehicular operational parameters as may be selected to be displayed to outside observers.

Display unit 20 is configured to include luminescent panels, such as panels 22-28, which have at least partially luminescent indicia, such as miniature light sources, which are interconnected to the wiring of the vehicle. Display unit 20 is preferably formed as a molded member of a sufficiently strong and resilient material with the display portion formed of a light transmissive material, the combination sealed from the elements. The luminescent source includes means for receiving individual indicia, such as a letter, numeral, words, or other indicia, for enabling customization of the message thereon. Thus, each luminescent source when lit will display the message of its respective indicia, for instance “BRAKE”. Each luminescent source is connected to a particular desired operational parameter to be monitored and will light up when this parameter reaches an operational status that is to be displayed. Otherwise the luminescent source is not lit.

The light source provided to the driver viewed interior information display 10 by the electrical system of the vehicle may also be provided to the remote display 20. The displays 10 and 20 may include indicia thereon which are not visible until backlit by the light source. A typical light source includes light emitting diodes; however, non-emitting, passive display elements such as liquid crystal displays may also be used. Alternately, the panels 22-28 may comprise a passive display wherein indicia are imprinted on a contrasting background for visibility without backlighting or other illumination.

Even though example display unit 20 has above been described, it is to be understood that it may take any appropriate configuration and be of any suitable material, the housing and lighting means determined as appropriate by the state of the art.

Additional vehicular operational status, as well as monitored driver information may be displayed. For instance, video monitors may be included to monitor the driver to detect potentially dangerous conditions such as head droop, or the like, to determine whether the driver is alert, and then to activate a warning to the driver, as well as provide a warning to outside observers, such as drivers of following vehicles. Similarly, other vehicular parameters, such as safety air bags may be monitored such as by various types of seat occupancy detectors, with information displayed or communicated as desired.

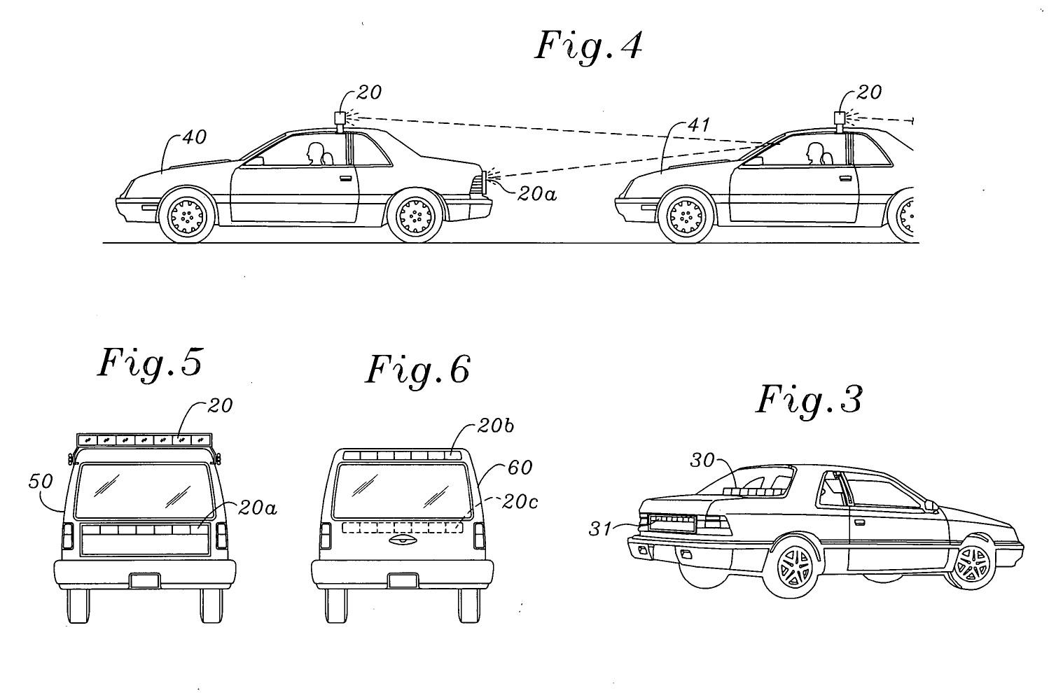

FIG. 3 illustrates an example of positioning of built-in displays for presenting vehicular operational status for visibility by observers exterior of the vehicle. As seen, a built-in display unit 30 may be mounted inside of a vehicle to be observed through the rear view window, and/or a built-in unit 31 may be positioned exterior of the vehicle, such as between the tail lights.

FIG. 4 is a plan view of an example of positioning of exterior displays for presenting vehicular operational status of a vehicle 40 to the driver of a following vehicle 41. As seen, an exterior display such as display 20 is mounted atop the vehicle 40, and/or unit 20 may be modified (designated 20a) and mounted exterior of the vehicle 40, such as between the tail lights. Vehicle 41 is shown similarly equipped as vehicle 40.

FIG. 5 is a plan view of another example of after-market positioning of displays for viewing of vehicular operational status exterior of the vehicle. As illustrated, a unit such as display 20 is mounted atop the vehicle 50 and a modified unit such as display 20a mounted to the rear of vehicle 50, such as between the tail lights.

FIG. 6 is a plan view of another example of built-in positioning of display units for viewing exterior of a vehicle, such as a sport utility vehicle (SUV). As illustrated, a modified unit 20b can built into the vehicle above the rear window, and/or a modified unit 20c built into the rear of the vehicle, such as between the tail lights.

The electronics of the invention can be designed so that certain critical information will override normal representations, such as when there is a variation from a selected range or when the rate of change from normal representations is undesirable. Examples of this include engine coolant temperature, oil pressure, tire pressure, fuel status, voltage, tire pressure, engine temperature, driver drowsiness, or the like. When such anomalies are present, the vehicle operator can be alerted during a pre-ignition test, at ignition, or during operation of the vehicle.

In addition to override or interruption of normal signal representations, audible signals may be used to alert the operator of the vehicle. These signals may be designed to continue for a period of time and then revert to a normal condition, or may be designed to interrupt and cease ignition procedures, that is, critical anomalies may be processed by the electronics to prevent initial ignition of the vehicle electrical system. The controller device may also include a storage medium for storing processed information with means to access such stored information.

The electronics may include means, by lights or audio, for a pre-trip inspection whereby the driver is queried according to a pre-selected check list including such items as medicine, money, cell phone, trip documents, etc., with the driver having means for verification of recognition of the reminder items.

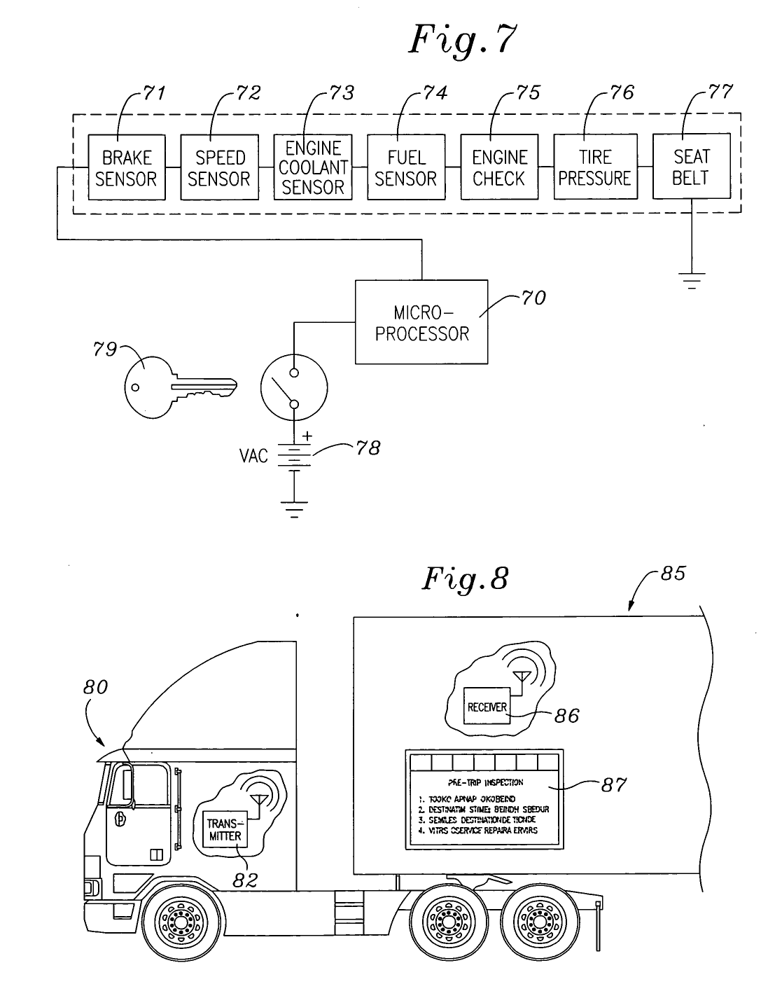

FIG. 7 is a functional block diagram depicting typical functions of the monitoring apparatus of the invention. A microprocessor or controller 70 receives signals from typical sensors 71-77 that monitor selected vehicular operational parameters, such as is displayed in panels 22-28 of FIG. 2, as well as driver alert status. A power supply 78 may be switch operated, such as by ignition-key 79. As known in the art, such microprocessors 70 include electronics for controlling multiple functions. In accordance with the invention, the microprocessor 70 receives inputs from the sensors 71-77 and responds to transmit appropriate signals to the associated display units. Provision can be made in the circuitry for password access, information resetting, and detection of tampering or disablement of the invention circuitry.

FIG. 8 is a side elevational view of a truck and trailer cargo vehicle comprising truck 80 and trailer 85, the truck 80 having wireless transmitter 82 for transmitting selected operational parameters to the wireless receiver 86 in trailer 85. As indicated, trailer 85 has exterior display 87 for exhibiting vehicle operational parameters as well as driver status as may be received by receiver 86. Commercial vehicles, or combinations such as truck and trailer cargo vehicles, are operated subject to certain legal restrictions imposed on the vehicle as well as the driver. Conformance with these restrictions can be monitored and displayed and/or transmitted by radio in accordance with the invention, thus alerting other law enforcement as well as other nearby vehicle drivers to any nonconformance. Examples of interest include discrepancies in the pre-ignition vehicle and driver checkouts, the condition of the brake system, use of the seat belt, Displays such as display 87 may be positioned on trailer 85 as desired, such as on the sides and/or the rear of trailer 85.

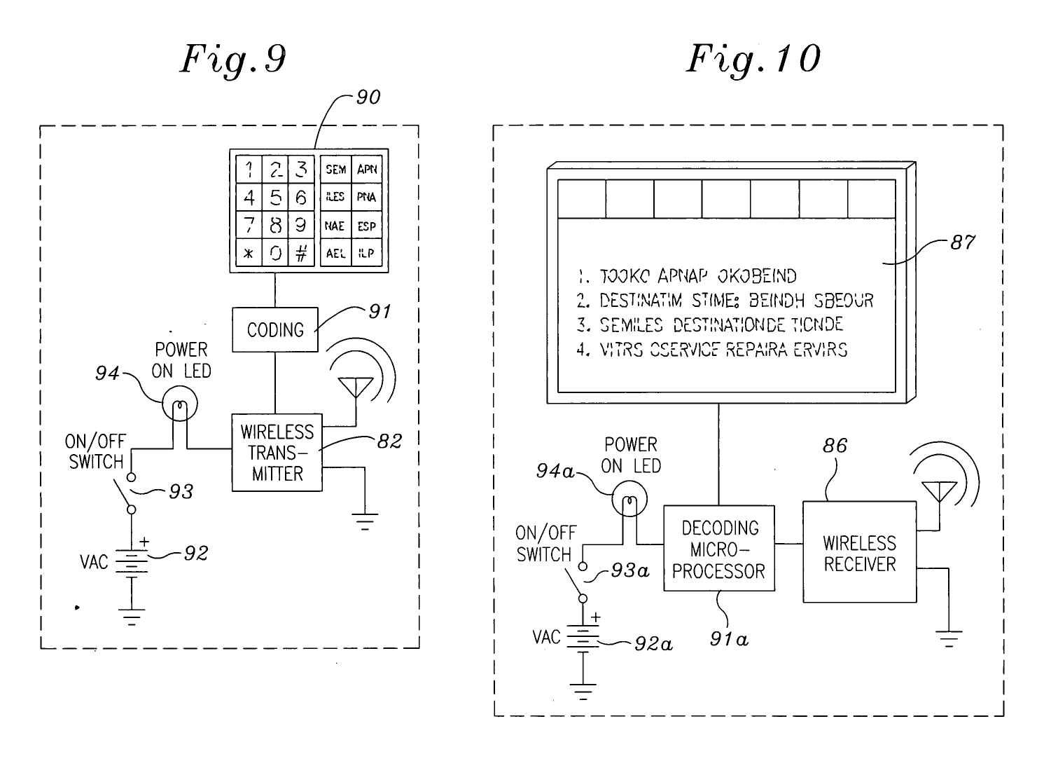

FIG. 9 is a functional block diagram further depicting various functions of the electrical circuitry of the monitor apparatus of the invention, including the use of wireless transmission of operational parameters. Shown is a key pad 90 for entering information into microprocessor 70 (FIG. 7) such as initiation of manual tests, reset of operational parameter guidelines such as maximum value or variation range, or initiation of wireless transmission of selected parameters to be transmitted by transmitter 82. Coding section 91 is included for coding and controlling of selected operational status features to be transmitted by wireless. Also shown are power supply 92, on-off switch 93 and power on-off indicator 94.

FIG. 10 is a functional block diagram further depicting functions of the circuitry of the monitor apparatus of the invention. Illustrated is receiver 86 for reception from transmitter 82 of wireless transmission of status information to be displayed by a display unit such as display 87. Decoding micro-processor 91a is included for selecting and/or decoding as necessary the status features transmitted by transmitter 82. Micro-processor 91a and receiver 86 may be combined as one unit. Also shown are power supply 92a, on-off switch 93a and power on-off indicator 94a.

Although not shown wireless receivers such as receiver 86 may be mounted in other vehicles, such as law enforcement vehicles for monitoring safety regulations, the transmitter 82 having adequate range and predetermined coding to facilitate identification of the transmitter 82 and thus of the sending vehicle. This would require a receiver such as receiver 86 as well as special electronics to be mounted in the law enforcement vehicle. With inclusion of a global positioning system the transmitter 82 can be modified to broadcast information for easy location of the transmitter 82.

There has thus been disclosed means for monitoring the status of vehicular operational conditions, including certain driver alert status, and when anomalies appear according to preset guidelines, providing means for displaying or otherwise communicating such status as desired either interior and/or for assessment exterior of a vehicle. The invention provides for automatic and manual monitoring of vehicle operational parameters at pre-ignition, at ignition, and during operation of the vehicle. In addition to override or interruption of normal signal representations, audible signals may be used to alert the operator of the vehicle. Provision is made for wireless communication of selected information to receivers exterior of the vehicle.

Although the present invention has been described in connection with an example embodiment thereof, it will be appreciated by those skilled in the art that additions, deletions, substitutions, and other modifications not specifically described herein may be made without departing from the spirit and scope of the invention.

1. Apparatus for monitoring controller processing and dissemination of a plurality of vehicular operational parameters, comprising:
monitoring device means for monitoring a plurality of vehicular operational parameters and
transmitting said operational parameters to display device means configured and located for dissemination of said operational parameters to observers interior exterior of said vehicle;
a controller device for processing said operational parameters for conformance with pre-selected standards and transmitting anomalies to said display device means; and
said controller device further includes means for monitoring and processing said operational parameters for cognizance exterior of said vehicle.

2. The apparatus of claim 1 wherein said a controller device further includes means for wireless transmission of said operational parameters to observers exterior of said vehicle.

3. (canceled)

4. (canceled)

5. The apparatus of claim 2 wherein said operational parameters includes unfastened seatbelt, excess speed, low brake fluid, low tire pressure, excess radiator temperature, low oil pressure, and low fuel.

6. The apparatus of claim 5 wherein said controller device includes means for conducting a pre-ignition inspection of anomalies of said parameters and upon detection of aberrations of said anomalies prevent ignition of said vehicle.

7. The apparatus of claim 6 wherein said controller device means includes means for providing real-time audio warning of operational anomalies and pre-trip inspection reminders to said driver.

8. Apparatus for monitoring, processing and presenting vehicle operational conditions, comprising:
means for monitoring and processing a plurality of selected vehicle operational conditions;
for conformance to pre-selected values and to changes thereof to determine objectionable variations; and
means for presenting said processed operational conditions for observer cognizance interior of said vehicle.

9. The apparatus of claim 8 wherein said means for processing said operational conditions includes means for presenting said conditions for cognizance exterior of said vehicle.

10. The apparatus of claim 9 wherein said means for monitoring and processing vehicle operational conditions includes means for conducting a pre-ignition inspection of said conditions and means and means for preventing vehicle ignition until selected anomalies of said conditions are rectified.

11. The apparatus of claim 9 wherein said means for presenting said processed operational conditions for observer cognizance exterior of said vehicle includes wireless transmission of said conditions.

12. The apparatus of claim 11 wherein said means for processing said operational conditions includes an electronic microcontroller having means for providing real-time audio warning of anomalies of said conditions and of pre-ignition inspection reminders to said driver.

13. The apparatus of claim 12 wherein said microcontroller includes a keypad for programming said microcontroller an accessible storage medium for storing processed information, and means for detecting and recording of tampering of said apparatus.

14. (canceled)

15. A monitoring, analysis and dissemination apparatus, comprising:
a controller device for processing vehicular operational information from a plurality of monitoring devices;
said controller device processing said operational information for conformance with pre-selected standards and transmitting anomalies to one or more dissemination devices;
wherein at least one of said dissemination devices is configured and located to provide observer cognizance of said anomalies interior of said vehicle and at least one to provide anomalies exterior of said vehicle; and
wherein said dissemination device for presenting said operational information for observer cognizance exterior of said vehicle includes wireless transmission of said operational information.

16. (canceled)

17. The apparatus of claim 16 wherein said controller device includes means for coding said operational information prior to wireless transmission and said apparatus includes wireless receiver means for decoding said operational information.

18. (canceled)

19. The apparatus of claim 17 wherein the at least one of said monitoring devices is a real-time video recording device located interior of said vehicle.

20. The apparatus of claim 19 wherein said controller device includes means for conducting a pre-ignition inspection of said processed operational information and means for providing real-time audio warning of operational anomalies and pre-trip inspection reminders to said driver and further having means for preventing vehicle ignition until selected anomalies or reminders are rectified.
